(19) United States
(12) Patent Application Publication
(10) Pub. No.: US 2013/0246382 A1
(43) Pub. Date: Sep. 19, 2013

(54) Ontology-based search engine in support of a decision support system

(71) Applicant: Simon J. Cantrell, Edge Water, MD (US)

(72) Inventor: Simon J. Cantrell, Edge Water, MD (US)

(21) Appl. No.: 13/385,973

(22) Filed: Mar. 19, 2012

(51) Int. Cl. G06F 17/30

(52) U.S. Cl. 707/706; 707/E17.108

(57) ABSTRACT

An ontology-based search engine enabling search criteria to be defined within a Virtual Earth visualization system. The search criteria can be entered directly as a set of ontology-based keywords or “search terms” and together with a number of optional spatio-temporal search criteria that are combined to become a spatial database query which is subsequently submitted to a spatial database whereby the search results are returned to the search client, for display directly into the Virtual Earth visualization system.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The need to provide timely decision support information has never been more acute than now, with climate change affecting almost all areas of human life, including weather, health, biodiversity, energy, water and sea level rise. The use of technology to provide an early warning system, has been long established with the introduction of early radar systems, during WWII, and the evolution of weather forecasting systems with the first flight of the GOES satellite in the 1960's, bringing imagery of the full Earth disc, to enable analysis of cloud cover, sea surface temperature and ocean color to be added to the growing list of data products available for climate scientists and forecasters to use. The evolution of information systems capable of cataloging and storing these data products has given rise to new demands for efficiencies in the design and organization of the metadata and data describing these products. In the United States, the Global Change Master Directory took a major step forward in crystallizing the directory and catalog design needed to handle the vast numbers of records, each containing spatial, temporal and associated metadata. The 1990s saw the introduction of information systems with the capability of storing, and retrieving petabytes of data with the NASA Data Active Archive Centers, and at their core, a catalog system, which featured a “Data Pyramid”, consisting of various layers, bridging data to its metadata. This is the first operational information system, which approached the ontology-based search and retrieval problem, in a systematic way. Although never fully achieving a full ontology-based search capability, it nevertheless possessed key design elements which are pre-cursors to future designs. The “Data Pyramid” possessed all the key layers of data organization, which provided the key to data organization within the catalog. Several external developments within industry were necessary before a fully implementable design of an ontology-based search and retrieval system would be possible. The maturation of a widely-accepted metadata standard was necessary to support the needs of users, data providers and the information architects responsible to assemble the information system alike. The evolution of a robust, reliable, and extensible database technology, capable of enabling the development and implementation of the information system, complex enough to handle a wide range of data products, and related metadata descriptions, and yet flexible enough to provide the necessary functionality to ensure the system is searchable and easy to use. The need to give rise to a decision support system, based on a reasoned, and logical framework, and capable of providing actionable data products of sufficient quality for use in predicting climate change is the final key element needed to enable the new technology leading to a fully implemented ontology-based search engine.

Now, with organizations, such as the Open Geospatial Consortium (OGC), actively promoting interoperability between users and data providers, it is now possible to enable the development, and implementation of an ontology-based search engine in support of a decision support information system

The systematic approach to the organization, design and implementation of such an ontology-based system is described herein, featuring the key design drivers, and responses to the needs of the users of decision aids in their abilities to help the prediction of the effects of climate change over a range of outlooks, including short term, mid-term and long term predictions.

The current GEOSS System provides an extensive set of components and services for collecting and searching of data and services, including the name, contents and management of the contributions of the various data providers and is a true system of systems.

A climate data analyst, or decision maker wishing to display actionable decision support data and information, usually has few search terms available to initiate the search, via a portal, or user interface. The principle is to distribute data and information via a Portal supported by a Clearinghouse, and to identify resources that may be of interest to users. Additionally, contributors are encouraged to configure their systems by means of a Components and Services registry, ultimately ensuring that data and information conforms to a widely accepted interoperability standard. Significantly, the contributors of a system such as GEOSS must play their part to ensure interoperability, as well as the system architects who design data and systems, who themselves are governed by international industry standards, e.g. OGC, FGDC and ISO. Users are required to comply with such standards in formulating their search terms which are subsequently submitted to the ontology-based search engine. This subject of this paper is therefore a systems appoach, which adheres to the stated interoperability standards, and thus enables a full ontology-based search capability across a wide range of data and information, which may be stored within a scalable, robust, and efficient catalog system.

Thus, the main feature of the proposed invention is to provide a new approach to ontology-based search system enabling the key technologies of search for data and information using ontology-based terms and database and information systems into a fully, interoperable capability whereby the search terms entered yield the right data and information to provide actionable decision support data products, necessary to predict the future effects of climate change. A unique feature of the invention is the ability to match the ontology-based search terms to be aligned to the GEOSS and OGC interoperability standards with the data sources used to populate the information system. The invention brings together a highly stratified ontology-based catalog, metadata schema, physical database implementation and the information system technologies into a new system capable of performing each of these steps 1n a robust and reliable fashion hence, providing decision support users the data and information needed for predicting the effects of climate change.

### FIELD OF THE INVENTION

The invention relates generally to the fields of metadata catalog, ontology-based search and retrieval, interoperability and decision support technologies. The benefit is to enable a user of a decision-support system to efficiently perform their search using ontology terms thus better serving the needs of the decision maker in his or her ability to predict the effects of climate change.

Description of Related Art including information disclosed under 37 CFR 1.97 and 1.98.

Field of Search: 364/444; 364/463; 364/449; 364/200; 364/300; 340/995; 365/228; 701/200; 701/208; 701/209; 701/211; 707/3; 701/206; 707/10; 707/E17.018; 709/217;

### REFERENCES CITED

### U.S. Patent Documents

U.S. Pat. No. 8,108,423 October 2008 System and method for ontology and rules based segmentation engine for network content delivery Treat et al. 707/771
U.S. Pat. No. 8,041,702 October 2007 Ontology-based search engine Eggebraate et al. 707/708; 707/715; 707/738
U.S. Pat. No. 7,917,492 March 2008 Method and subsystem for information acquisition and aggregation to facilitate ontology and language-model generation within a context-search-service system Bargeron et al. 707/708; 707/709; 707/711; 707/740; 707/741; 707/755; 707/770; 707/771;
U.S. Pat. No. 7,472,109 December 2008 Method for optimization of temporal and spatial data processing Katibah, et al. 707/3; 707/103Y; 707/E17.018
U.S. Pat. No. 7,254,589 May 2004 Apparatus and method for managing and inferencing contextual relationships accessed by the context engine to answer queries received from the application program interface, wherein ontology manager is operationally coupled to with a working memory Goodwin et al. 1/1; 707/999.003; 707/999.102; 707/999.104; 707/999.107;
U.S. Pat. No. 6,728,692 December 2004 Apparatus for a multi-modal ontology engine Martinka et al. 706/45; 706/46; 706/47
U.S. Pat. No. 5,528,518 June 1996 System and method for collecting data used to form a geographic information system database Bradshaw et al. 364/561; 364/449; 364/560;

### BRIEF SUMMARY OF THE INVENTION

The key elements of the present invention are the capability of ontology-based search, based on a ontology search term an information system with the capability of being able to recognize the search term, or terms and relate this to a wide range of data information, and match the terms to return a limited set of desirable, actionable data products, hence enabling better decision support predicting the effects of climate change.

### BRIEF DESCRIPTION OF THE SEVERAL VIEWS OF THE DRAWINGS

A better appreciation of the invention and many of the inherent advantages will be more readily apparent by reference to the detailed description and the accompanying drawings wherein:

FIG. 1 is a schematic representation of the ontology-based search engine in support of Decision Support of the present invention;

FIG. 2 is a specification of the schema;

FIG. 3 represents an illustration of a ontology relationship between a key term, e.g. “flood”, and the associated terms, “marsh”, “wetland”, and its specific instances: “bog”, “swamp” and “fen”;

FIG. 4 represents a search-based user interface which allows a simple or complex search term to be entered via a simple text box; results are returned as a list, of hyperlinks, and the spatial extents of the data sets are represented on a map, to the bottom right of the pane, each extent is outlined via a red box

FIG. 5 represents a browse user interface which allows users to select from a number of categories within the catalog, or simply open up each category to reveal the list of data sets contained within each category;

FIG. 6 represents a result displayed in the map viewer interface, in this case a global sea level rise data product;

FIG. 7 represents another result displayed in the map viewer interface, in this case a global map of precipitation;

Drawings: 7 Drawings on 4 sheets to follow:

### ORIGIN OF THE INVENTION

This invention evolved over time from the alignment of the needs of the decision support users, in their ability to predict climate change, to the greater availability of various disparate data and information: and the more widespread adherence to interoperability standards, to enable the provision of an ontology-based search system in support of a decision support system, where the results of a search may lead to timely and reliable decision-making to avert the potentially damaging effects of climate change. The innovation for the proposed invention is to enable decision-makers easier access to the right kind of information in a reliable and repeatable fashion.

### DETAILED DESCRIPTION

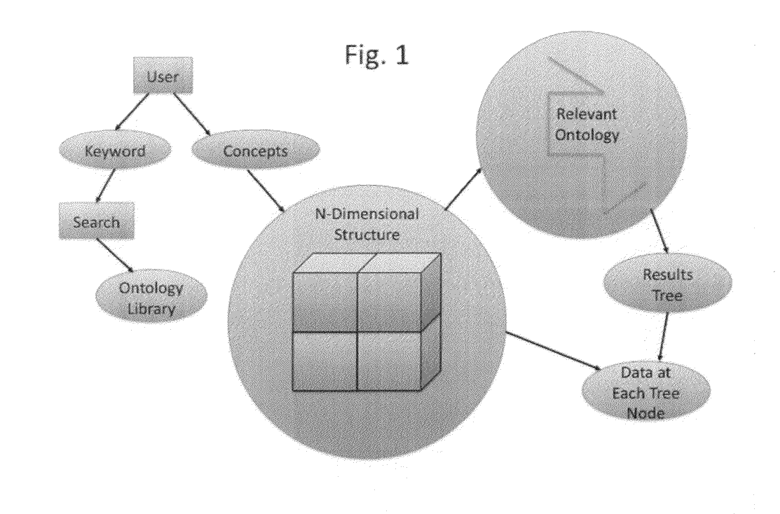

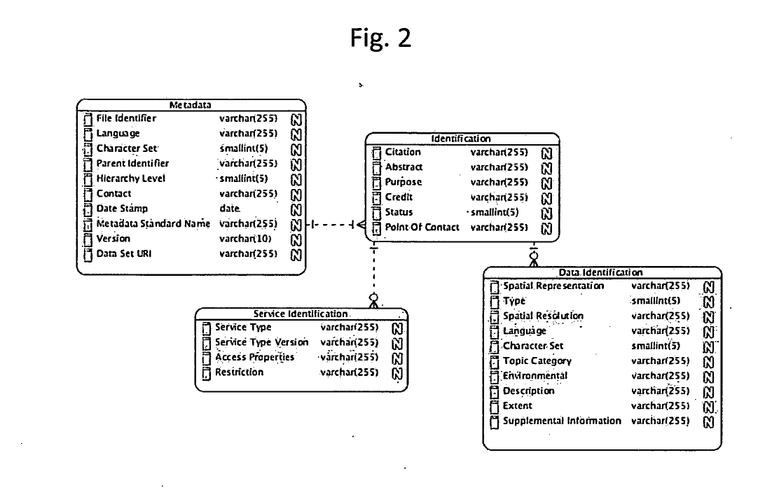

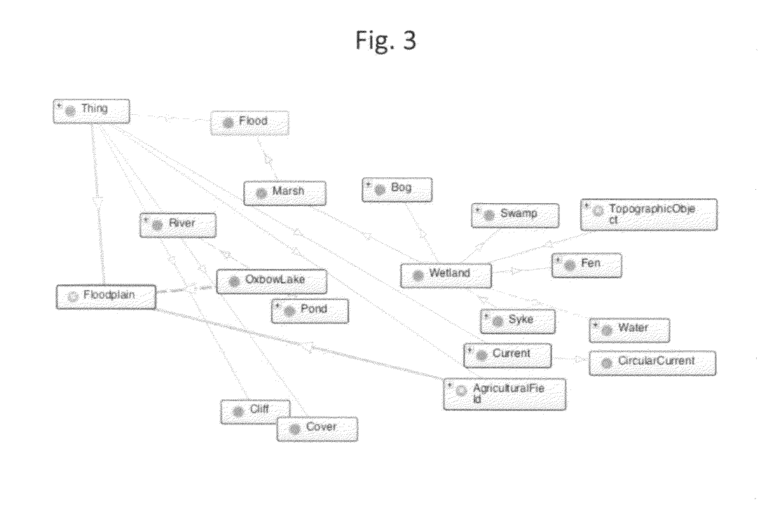

Referring to the drawings, and in particular to FIG. 1 is a schematic representation of the ontology-based search engine as shown. A key concept of the ontology-based search system is that it can support searches based on the ontology terms, which are known to the user, and are widely accepted in the community. FIG. 2 is a specification of the schema. FIG. 3 represents an ontology relationship between a key term, e.g.

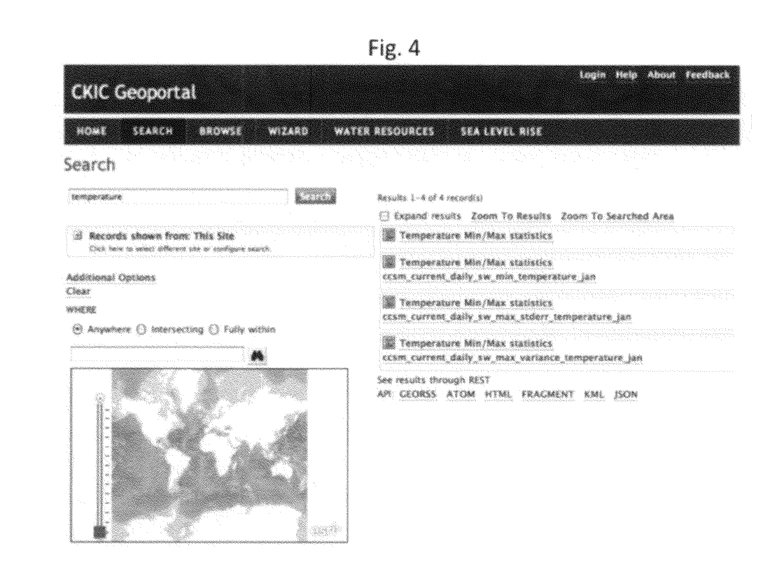

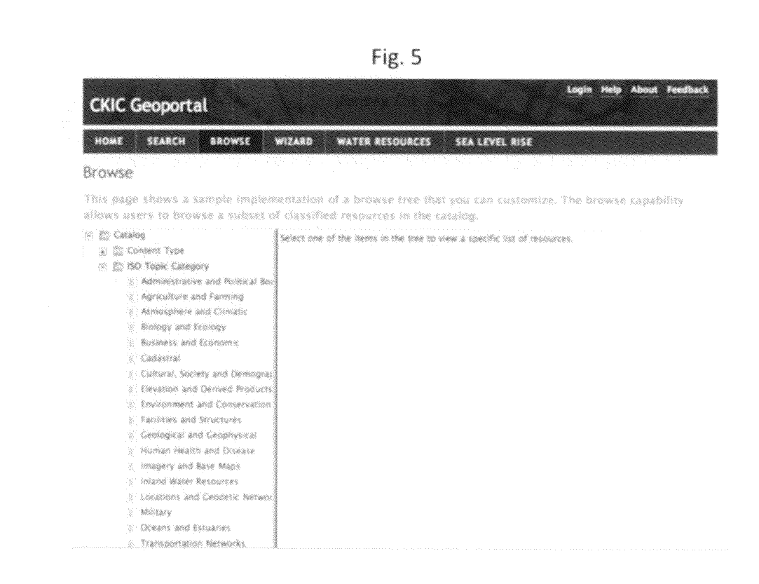

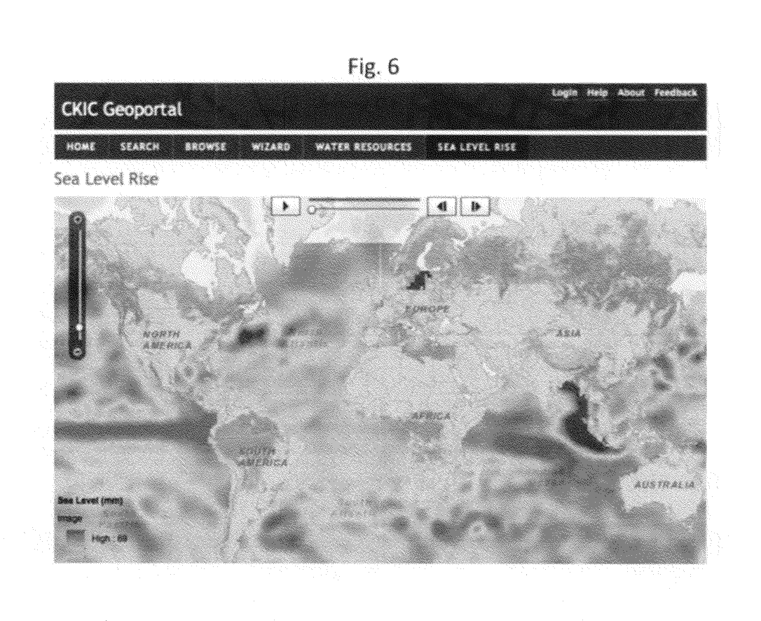

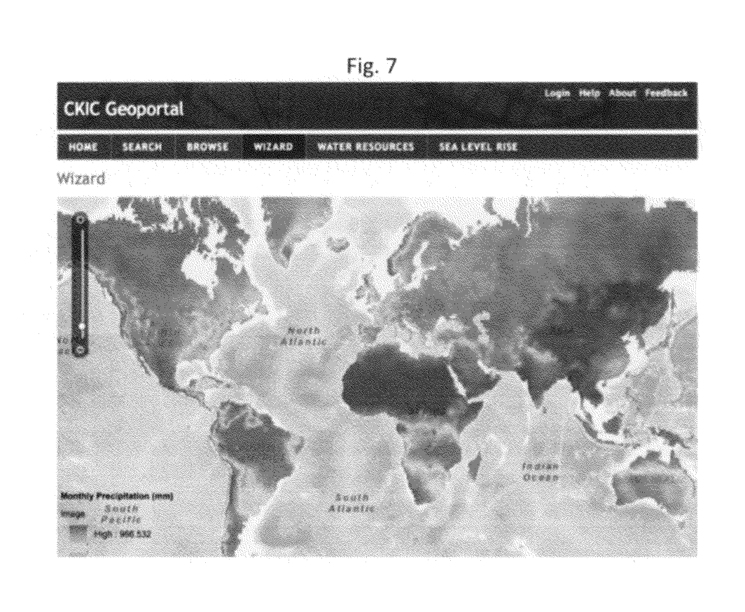

“flood”, and the associated terms, “marsh”, “wetland”, and its specific instances: “bog”, “swamp” and “fen”. FIG. 4 is a screen capture of the search screen of the geoportal. FIG. 5 is a screen capture of the browse screen of the geoportal. FIG. 6 is a screen capture of a sea level rise data product displayed in the map viewer. FIG. 7 is a screen capture of a global precipitation data product displayed in the map viewer.

The process of collecting and analyzing the requirements has resulted in a data model, representing entities or objects, which are real world in nature, and have attributes, or characteristics. These object naturally fall into the categories, known to the user, and which are likely to be the subject of any searches made. Compared to previous data models, which exhibit layers, and associated functionality between the layers, which may represent relationships between the objects, the real world is more complex that a simple layered mode, hence this invention features a matrix of layers or nodes pointing to layers, which enables relationships to exist in the data model, not supported by the simple layered model. Hence, the matrix mode can better represent real world relationships between the entities, or objects modeled leading to a higher degree of success in locating objects of interest, where real world relationships are maintained within the model, and within the physical implementation of the model, as an N-dimensional structure. This forms the basis of the ontology-based search capability described herein. If is the objects which are represented in a way close to their true position within this structure, then is fundamentally possible to codify the ontology-based search engine with modern information system technologies, ensuring that the model structure is faithfully reproduced within the memory of the computer, and specifically in the catalog, at the heart of the information system database schema and corresponding table structure. The data engineering process followed as part of the implementation phase of the ontology-based search engine is crucial, therefore, in ensuring the conceptual model of the N-dimensional data structure is mapped accurately to the physical model, and in the execution of the Data Definition Language (DDL) of the chosen database technology. Another aspect of the organization of the catalog is the adherence to standards, in terms of both metadata and data. If the data and metadata can be considered in terms that are closely related to international standards, then the information system is more likely to be able to readily hold complete records for those data and metadata. One of the lessons learned from previous systems, such as NASA's EOSDIS Core System, the data and information may be provided in a wide variety of formats, for model data or earth science data. e.g. SFDU, netCDF, BUFR, GRIB, FITS, HDF. Metadata, specifically metadata populated into the headers of these files, is very widely varying, and is often incomplete. It follows then, that one size does not fit all, specifically, one data format does not suit all purposes, and in terms of information systems architectural design, if a single standard is chosen, arbitrary an ontology-based search which can meet varying user requirements. Flexibility is therefore a desirable design driver and other systems, such as NTOVS, have enabled this flexibility, often leading to problems in the other extreme, where the final system implementation is too flexible, and that users often take advantage of this flexibility to the detriment of other users. The ontology-based search engine presented here is flexible to meet varying user needs, but specific enough to adhere to international mandatory interoperability standards, resulting in an optimally-balanced system architecture. For example, data are only returned from a search if they fall within the grouping defined by the associations between the ontology keyword provided and the related concepts and any other search terms used to narrow down the results sets. Further refinement of the query results set may be provided by means of query expansion, whereby further terms can be added to the search query, either by addition or rephrasing the search term. This search may be tuned by differentiating between specializations and generalizations of items contained within the ontology trees. In the general case, an ontology may be organized into a tree, where the child nodes representative of the specializations and the parent nodes represent the generalizations. It follows that the specialization can be used to tune the search to be more refined, while the generalizations may be used to make the search broader.

In executing the ontology search a well-defined set of metadata can be searched to compare the ontologies, i.e. the real world representations of the entities or concepts and the spatial and temporal ranges represented by the data being searched. Since data may exist in a whole range of states in space, then the ontology-based search enables a well-defined, holistic approach to determine the outcomes of a search, which provides rules for the ontology rule-based database to perform the textual search. The Basic Ontology Names and their descriptions and types are found in the matrix of Table I below.

TABLE I
Basic Ontology

| Name | Description | Type |
|---|---|---|
| Metadata | File Identifier | String |
| | Language | String |
| | Character Set | Code |
| | Parent Identifier | String |
| | Hierarchy Level | Code |
| | Contact | String |
| | Date Stamp | Date |
| | Metadata Standard Name | String |
| | Metadata Standard | String |
| | Version | |
| | Data Set URI | String |
| Identification | Citation | String |
| | Abstract | String |
| | Purpose | String |
| | Credit | String |
| | Status | Code |
| | Point Of Contact | String |
| Data_identification | Spatial Representation | Code |
| | Type | |
| | Spatial Resolution | Resolution |
| | Language | String |
| | Character Set | Code |
| | Topic Category | String |
| | Environmental | String |
| | Description | |
| | Extent | Spatial Extent |
| | Supplemental Information | String |
| Service Identification | Service Type | String |
| | Service Type Version | String |
| | Access Properties | String |
| | Restriction | Constraints |

Similarly, the data, or collections of data may be organized in a formalistic manner, to ensure the information resources elements of the search may be shown to comply to a set of widely-accepted interoperability standards. These information resources may be found in Table II below.

TABLE II
Information Resources

| Information | | |
|---|---|---|
| Resource | Description | Interoperability Standard |
| Dataset | An identifiable collection | ISO 19115 |
| | of data | |
| Datacollection | A collection of datasets | ISO 19115 |
| | sharing the same product | |
| Service | A service instance hosted | ISO 19119 |
| | on a specific set of | |
| | hardware and accessible | |
| | over a network. A service | |
| | is tightly coupled, loosely | |
| | coupled or mixed coupled. | |
| Loosely coupled | A service instance that in | ISO 19119 |
| | not associated with a | |
| | specific dataset or | |
| | datasetcollection. Loosely | |
| | coupled services may have | |
| | an association with data | |
| | types through the service | |
| | type definition. Dataset | |
| | metadata need not be | |
| | provided in the service | |
| | metadata. | |
| Tightly Coupled | A service that is | ISO 19119/ISO 19115 |
| | associated with specific | |
| | datasets or | |
| | datasetcollections. Service | |
| | metadata shall describe | |
| | both the service and the | |
| | geographic dataset, the | |
| | latter being defined in | |
| | accordance with | |
| | ISO19115. | |
| Mixed Coupled | A service that is | ISO 19119/ISO 19115 |
| | associated with specific | |
| | datasets or | |
| | datasetcollections. Service | |
| | metadata shall describe | |
| | both the service and the | |
| | geographic dataset, the | |
| | latter being defined in | |
| | accordance with | |
| | ISO19115. But this service | |
| | instance can also be used | |
| | with external data (i.e. | |
| | data that is not described | |
| | by the operatesOn | |
| | association). | |
| Application | An information resource | ISO 19115 |
| | that is hosted on a specific | |
| | set of hardware and | |
| | accessible over a network. | |

The other data and services, e.g. metadata discovery, harvesting, validation, etc. may be provided by different parts of the interoperability standards, which are not specifically the subject of this invention, but form an essential step in data discovery, quality checking, and dissemination, in terms of preparing data and metadata the search results, hence enhancing the useability of data sets for decision support.

A key aspect of the invention is the way in which the search is specified within the computer system. The ontology needed for the decision support system is typical of an ontology needed for the sciences, specifically the atmospheric sciences, or areas of concern to the users, i.e. Climate, Weather, Agriculture, Health, Water, Disasters, Energy, and Biodiversity. Therefore, since these areas of concern are related through more than one plane, the internal model of these real world concepts will need to be mapped to more than one plane, or collection of planes, and this gives rise to an N-dimensional matrix. The resultant node map is an N-Dimensional structure, which will yield a node, or collection of nodes as a result set.

The overall method is shown in FIG. 1. The user starts the process by entering in keywords, or search terms, which, in their minds maps to real world concepts. Hence the understanding of the mapping between real-world entities and the search criteria are first made by the user, and simply entered into via a user interface, and stored along with the spatial and temporal criteria in readiness for the ontology-based search. The next step in the process is the search itself, which is handled by the database system, whereby the keywords, and the associated concepts, are submitted in a format specific to that database and in a structure, which retains the logical association of keywords to concepts. The user is responsible for checking all the search criteria prior to executing the ontology-based query, and this is more this can be done semantically, of via a syntax checker, which is provided as part of the user interface. The success of the search is also dependent on the data provider having made a suitable associate between the metadata keywords tagged on the data, during the ingest, or submission process, and that the associations between the metadata keywords and the concepts retained these associations as the metadata record creation process. Therefore a novel approach to ensuring that the important associations of keywords (metadata) and concepts (real-world representations of the concepts) proposed for the proposed invention is that the keywords and concepts may be associated via an “N-Dimensional” structure which may be most readily achieved within the memory of the computer system by assigning a suitable array structure. Other associated searchable metadata may be including spatial and non-spatial metadata and information, may be stored via the conventional spatio-temporal database during the ingest process ready to be compared to during the ontology-based search. For example, a search for a dataset may have science parameters tagged to it, for example, the keyword “cloud” may have an associated with the concept “mesoscale”, or the keyword “flood” may have the concept “exotropic” associated with it. The scientific metadata, i.e., representations of data, whether it is model data, earth observation data, or in-situ data, where scientific keywords, or concepts relating to real-world entities, which are commonly searched must retain the same kinds of associations which are tagged to the data at the time of creation. Numeric, or statistical representations of real-world entities may be represented by maximum or minimum values or ranges of values, and for a given time period, this may define a statistical component of the search. An interesting aspect of the invention, which will enhanced its usefulness, especially to science researchers and climatologists, is that the invention takes advantage of recent advances in data formats, and the ability for data to be “self-describing”. For example, in defining a data set, a data provider must complete a more rigorous description of the data, as part of the metadata tagging process, to include science parameters in terms of their maximums, or minimums, or both, and, if the variables within the data have a statistical meaning, to include a summary in the metadata, representative of that data. Hence, for example, for heating and cooling degree day data mean and standard deviation, and variance of the mean, and variance of the standard deviation, can be included in the metadata, along with other useful information, such as source, data heritage information, etc. So when a user specifies an ontology-based search, the onus is on them to define search terms. with the previously defined ontologies for the standard deviation of heating degree days, for first week of January, in a given year, or over a range of years. Here, it becomes clear that the ontology-based search criteria can become quite complex and that the mechanisms for association of keywords and concepts, with in the spatio-temporal database system, and the “N-dimensional structure”, which is a novel feature of this invention, enables better results to be returned following an ontology-based search, that was previously achievable, using conventional search-based systems. Many of today's database systems, e.g. Oracle, Sybase and Informix, and quite capable of rendering the spatio-temporal searches using conventional representations of the metadata. However, with the added capability of the “N-dimensional structure” in combination with a willingness on the part of the data providers to tag the data correctly, then a truly powerful ontology-based search capability is possible, to return specifically the desired datasets. The main aspect of the proposed invention is to facilitate the execution of the ontology-based search and return of the relevant ontology which are contained within the results tree, whereby each node in the tree maps to a desired keyword and associated concept, in terms which enable immediate retrieval of the desired data, whether in terms of scientific values, or simply by tagging the data to a stored data set or statistical representation of the data set or other data associations.

This is made possible by the inclusion of two key technologies: the ontology library and the results tree, in addition to the N-dimensional structure which maintains the associations between the keywords and key concepts.

The ontology library is the storehouse of the ontologies which is capable of accepting a wide variety of keyword parameters, including, all the key terms which the users are likely to submit during the search, and maintaining the associated concepts correctly. The ontology library can be preloaded, at the time of the creation of the library, or can acquire additional ontologies to add to the knowledgebase as part of the ingest process, resulting in a complete knowledge of the expected keyword and concept syntax, therefore allowing the widest range of variability of user-defined ontology-based search criteria. Therefore, the ontology library can build up a representation of the real world over time, in terms of which are generally accepted and be composed of a wide range of parameters, including, but not limited to scientific data set names, descriptions, science parameters, and other attributes which maybe tagged to the data, and the associated concepts, which will yield a richer set of results, but provide the user with control over the variability of the relevancy of the returned results tree. The results tree is composed principally of a nodal structure, which retains just those keywords and concepts found within the “N-dimensional structure” during the execution of a search, and limited further by the constraints of the spatio-temporal search performed by the conventional spatial database search.

The spatial database is a standard commercially available spatial database application, containing all the data and information, which are subject to search. A decision support user will often need to discover data and information of interest, and may not have an awareness of the density or scarcity of the data available. This is where the power of the ontology-based search comes into its own. Take for example the decision-maker who looks forward to discovering the effects of climate change on sea level rise affecting a port, or another who is determining the risk of building in an area close to the flood plain of a river delta. So, if a layman seeks to learn what the peak sea level rise could be, or the flood extent of a river, then they could enter the terms “sea level” or “river”, or “precipitation”, but without following a logical breakdown of all related terms, would be likely to fail to return data and information which could be useful in seeing the full picture. Historical records and decadal trends will provide one such view of the potential for flooding, and choices which include current and future models, will enable a predicative view of the situation. A true ontology-based search will trace the search term through an associative tree, which will include all such terms, which can be traced from the source term. Therefore terms such as “flood extent”, “hydrology”, “drainage”, and such like will also be associated with the search, hence returning data and information, tagged with these terms, to make the results set more useful. Ideally, a scientist, or hydrology expert, could make these associations manually, and hence drive a richer search, but that knowledge can be taught to the ontology-based search system, through a series of rules, and algorithms, which are the subject of the invention. Therefore, the ontology-based search system being proposed is designed to acquire a knowledge of the associations between commonly used search terms, and this knowledge-base will grow, hence making the system, more likely to return data and information desired by the user, whether a layman or a specialist in the field.

An added benefit of the proposed invention, is that in the event of a disaster or national emergency, where a set of geographically and topic-based data and information is generated very rapidly, then, each search will quickly build up a new set of associations which will help to get the most sought after information back within the results sets. This knowledge acquisition phase is a very important capability, not present within other ontology-based search systems. It is important to point out that this capability is only limited by the size of the storage needed to hold the associations in memory, or other short-term data storage mediums. Although the choice of database technology used as part of the search, may yield slightly different results, due to differences in the methods of performing the basic logical associations, on the whole, the data schemas representing the ontology, if well-defined, and designed to conform to information systems data interoperability standards, will yield comparable results. The presentation of the results sets, and the visualization of the results is best achieved via a common visual interface. The merit of the proposed invention is the ability to represent these as associated layers or textual relationships using an ontology language, such as RDF. For example, in this ontology description for “hydrology”, the initial term may be “flood” and the first relationship may be “wetland”, which is a special case of a “topological object”, with examples of “wetland” being “bog”, “swamp” and “fen” as shown in FIG. 3. For simplicity, they may be considered as associated layers or concepts coincident within the user provided search term “flood”, or “flood plain”, which was submitted via the decision support layer client program.

The ontology search is powered by an inference engine and for the proposed invention, is comprised of a Ontology Inference Service (OIS), capable of being preloaded with a comprehensive set of ontologies, each covering specialization, generalization and equivalence of a concept, besides being able to search for all satisfying instances of a concept, dependent upon the initial search criteria provided, and formatting these results into a limited results tree, which can be parsed out and presented in a human-readable form. The W3C definition of the Resource Description Framework (RDF) provides a simple but powerful tuple-based representation for semantic representation of the ontologies and the possible results sets, which also retain the tree structure including essential keywords, and associated concepts, which may be returned from the search. The query interface is a standard web page which provides access to a description logic reasoner, which returns the results through an HTTP-based interface. The information is commonly encapsulated within the RDF format, and a merit of the proposed invention is that the results tree can represent the results tree into an RDF file for direct display in a tree structure form. The resultant display shows, where appropriate, tree structures representing the results sets and a mapping to data at each leaf node. Any information about the data, can be mapped or tagged to the data, e.g. source, or the authorship of the climate data sets. It will provide an easy way to navigate the tree structure and to read or access the data directly, or simply to read about the data, via its metadata.

Referring to FIG. 4, the spatial search terms are entered into the client program and are transformed into a Lucene syntax query. This enables a set of search terms such as “title” or “abstract” like “floodplain” or “flow” to be entered, for example, by entering title: like | floodplain which can be passed to the ontology service, in preparation for query processing. Alternatively, the OpenSearch method may be used whereby a search term may be entered into a browser which supports the OpenSearch, such as Mozilla Firefox 3 or Internet Explorer 7 or 8. Simply navigate to the URL located at: http://[host]/geoportal/OpenSearchDescription, and enter the search terms.

In the Search Page Results pane of the geoportal shown in FIG. 5, there are a set of search results shown. The results sets are listed on a search results page, showing the data sets which have been returned from a query. In this example, a set of options are provided to enable the users to evaluate discovered resources. As shown in FIG. 5, each of the categories may be browsed, and give a user the means to evaluate, access data sets, based on category selection, i.e. by choosing the appropriate content type or ISO Topic Category. Once a data set has been identified its metadata can be inspected within a viewer, or the geo-referenced data itself may be viewed on a map viewer, or downloaded directly to the user's computer.

In addition, referring now to FIG. 6, the current selection is to enable a selection of data sets via a simplified user interface

Benefits of the current ontology system use of common key words derived from ontology-based libraries, development of key words, use of scientific terms, ease of addition of search terms to data sets, common method of tagging files, common method of tagging files at time of ingest into the geoportal

Future developments are: to develop a search mechanisms, which allows data to be searched via local and remote hosts, search of local file systems. search of remote file systems

Referring to FIG. 7, the results set may be shown directly in a viewer, and the user may select either data or metadata, and the data set representing a result is best displayed in the map viewer interface, in this case a sea level rise data product.

Referring to FIG. 8, represents another result displayed in the map viewer interface, in this case a global map of precipitation.

Current spatial search systems providing comparable functionality, i.e. NASA's Giovanii provide a spatial and textual user interface for the user to define and save the search criteria prior to submitting a spatial query, however, the limitation is that the spatial query can only generate visualizations following a search, and that is not done dynamically at the time of submission. Users are given the opportunity to provide the search criteria by means of a search “region-of-interest” having only a bounding rectangle, rather than from a keyword-based ontology search term, which is a capability of the proposed invention. Also, once the query is submitted, then the time taken for the search to execute varies between a few minutes and a few hours, and once complete the results sets are often returned prior to generation of the visualization data products. For example, if the user requested MODIS data, which contains 3D information of cloud structures, during the Hurricane season, of fall 2004, over the Eastern seaboard, then the results would be rendered in a Hierarchical Data Format (HDF) native format or Keyhole Markup Language (KML) format and within the date range of the selected dates, and each would need to be downloaded separately on the user desktop or workstation, for reformatting, and data conversion, prior to display on a user display program which is capable of rendering the reformatted, spatial data sets.

In the proposed invention, all the above steps occur within the ontology-based search engine system, and results data sets are displayed on-the-fly within the visualization system. An advantage of the invention, is that if a DoD decision-maker, or NOAA/National Weather Service weather forecaster, wanted to locate and retrieve data sets, which are known by the same or similar ontology-based search terms, this could be done simply by entering the search term into a text box, with coincident data represented simultaneously within the Virtual Earth visualization system, supported by the Ontology-based Search Engine, configured in the manner described herein.

As developed, the ontology-based search engine support of a decision support system will represent new data from the IPCC 4 and 5 projects, existing data from Earth Science Grid, and data from the National Climatic Data Center on-line systems, i.e. NOAA's NCDC archive. Data can be added to the ontology-based search system, based on the RDF graph format, i.e. ttl, .rdf, .owl, It is anticipated that remotely-sensed data may be used to extend the search “footprint” the local system via a customized ingest software technology, and the this addition saves the need to extend the storage capacity of the local system in order to offer ontology-based search and retrieval of the new data.

Thus the details of the invention have been described, in summary it provides a fully, interoperable ontology-based search system a capable of being searched the search terms which yields actionable decision support data products, which are necessary to predict the future effects of climate change. It aligns the ontology-based search terms to the GEOSS and OGC interoperability standards with the data sources used to populate the information system. It brings together a highly stratified ontology-based catalog, metadata schema, physical database implementation and the information system technologies into a new system capable of performing each of these steps 1n a robust and reliable fashion hence, providing decision support users the data and information needed for predicting the effects of climate change.

What is claimed as new and desired to be secured by Letters Patent of the United States is:

1. An efficient method of enabling an ontology-based search to be executed and submitted to an ontology library, and subsequently to an “N-dimensional structure”, and supported by a conventional spatio-temporal database, executed within a client program, whereby a results tree is returned for the relevant ontology:
(a) a fully, interoperable ontology-based search system a capable of being searched the search terms which yields actionable decision support data products;
(b) following a search, the results data sets are displayed on-the-fly within the visualization system;

2. The method of claim 1 wherein the ontology-based search terms aligns to the GEOSS and OGC interoperability standards with the data sources used to populate the information system.

3. The method of claim 1 wherein a display of the “bounding-boxes” which represent the spatial extent of each data set returned, is rendered within the search pane, which provides a preview of the visualization system.

4. The method of claim 1 wherein a list of results data sets, which contains links to the data and metadata of each result, is rendered within the search pane of the visualization system.

5. The method of claim 1 wherein a user search pane for the ontology-based search criteria is rendered within the search pane, which forms part of the geoportal. for the spatial database, which is running on the computer processor.

6. The method of claim 1 wherein a spatial database which contains all searchable records and universal record indicators (URIs) for each of the results data sets provides the ontology-based search engine returning the results sets from the search.
The ontology-based search engine in support of Decision Support system provides systematic, highly configurable, provision for user definition of a set of ontology search terms, including ontology relationships and within the context of the Decision support system, provide a comprehensive ontology-based search system, capable of executing a wide variety of Open Geospatial Group (OGC) compliant ontology-based queries, using any of the basic ontologies shown in Table I, together with information resources shown in Table II, the search results may be returned contain desired data, which is displayed in the Decision Support system. The potential applications for the proposed invention are considerable. If the system was to be implemented in a client-server arrangement with a Decision Support system, then highly selectable data, which is determined by the contents of the N-dimensional structure. The proposed invention can be implemented within a wide variety of configurations, in order to optimize the construction of the results data set, provided each of the elements illustrated in FIG. 1 are present in the system.
Examples of potential applications include decision support, systems, for example an insurance company or a bank which is looking to offer a loan on property at a location near the coastline will be looking to make decisions based on the availability of high quality, accurate data which is derived from either climate models or weather systems like those which are currently available within the Earth Science Grid (ESG), or NOAA's Advanced Weather Information Processing System (AWIPS). The validity of the new, higher resolution data sets require validation, prior to publication, or widespread by the decision support user community, especially if the data forms part of any work with any liability associated with it. One such undertaking is NOAA's quest to standup a national climate service. Here many decision makers will look to NOAA to supply the data and metadata necessary to make decisions, sourced from a variety of global climate circulation models, with contain variables such as: temperature, precipitation, snowfall, sea-level rise, and these data and metadata can be compared with data representing human activity, or natural or man-made infrastructures i.e. populations, rivers, lakes, roads etc. The availability of historical data, future predictions, in the short-term, mid-term and long-term will allow trends in the scientific indicators to be revealed and analyzed over many decades, dependent upon the validity of the data. Much of that data possesses rich temporal and spatial information, and depending upon the sophistication of the decision support system, can be manipulated to allow a simplified means to perform reliable and meaningful decisions, as a result of ontology-based searching of that data.
Another potential application is the provision of 3D or even 4D data to the ontology-based systems. For example, the airlines industry needs to access weather data pertaining to a storm system, which is either predicted in the near future, or is happening at the time of search and if these data and metadata are immediately made available within a Decision Support system, then very quick decisions may be possible, perhaps to avoid loss of life in the air, by diversion of flights, or on land, or sea, by the early announcement of a pending tsunami wave. The present invention can be extended to favor certain associations between data and metadata identified by the search engine, in terms of maintaining these associations within the database system, which contains these data, and the ontology-based search terms. The results sets can be returned directly to the user with these associations intact, and listed within the search pane of the geoportal. In this way, searches which may aid decision makers who search for tsunami or sea-level data, may see affected populations returned with the results sets.
